(19) United States
(12) Patent Application Publication
(10) Pub. No.: US 2008/0129657 A1
(43) Pub. Date: Jun. 5, 2008

(54) Plasma display panel

(76) Inventor: Jung-Suk Song, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/985,755

(22) Filed: Nov. 16, 2007

(30) Foreign Application Priority Data
Nov. 20, 2006 (KR) 10-2006-0114711

(51) Int. Cl. G09G 3/28

(52) U.S. Cl. 345/60

(57) ABSTRACT

A plasma display panel is disclosed. In one embodiment, the panel includes i) a substrate in which a display area where an image is displayed and a non-display area outside the display area are defined, ii) a plurality of discharge electrodes that extend from the display area to the non-display area and are patterned to have different lengths from each other, iii) a plurality of dielectric layers that bury the discharge electrodes and have different areas for burying each of a plurality of electrode terminals extending from the discharge electrodes and iv) a signal transmitting unit that is electrically connected to the electrode terminals and comprises lead terminals in positions of the signal transmitting unit corresponding to the electrode terminals. The plasma display panel can prevent a short circuit between adjacent discharge electrodes by combining lead terminals of the signal transmitting unit with the discharge electrodes having different lengths from each other.

### CROSS-REFERENCE TO RELATED PATENT APPLICATION

This application claims the benefit of Korean Patent Application No. 10-2006-0114711, filed on Nov. 20, 2006, in the Korean Intellectual Property Office, the disclosure of which is incorporated herein in its entirety by reference.

### BACKGROUND OF THE INVENTION

1. Field of the Invention

The present invention relates to a plasma display panel, and more particularly, to a plasma display panel having a structure that can prevent a short circuit when discharge electrodes are connected to signal transmitting units.

2. Description of the Related Technology

A plasma display panel (PDP) is a flat display panel that displays desired images using visible light emitted from a phosphor layer which is excited due to ultraviolet rays generated from a discharge gas filled in sealed spaces between substrates facing each other, and on which a plurality of discharge electrodes are formed.

### SUMMARY OF CERTAIN INVENTIVE ASPECTS

One aspect of the present invention provides a plasma display panel that can prevent short circuits between adjacent discharge electrodes by modifying positions for combining a plurality of discharge electrode terminals with a plurality of lead terminals.

Another aspect of the present invention provides a plasma display panel in which positions of align marks that are used for combining the electrode terminals with a signal transmitting unit are modified so that the alignment of positions between the electrode terminals and the lead terminals can be readily achieved.

Another aspect of the present invention provides a plasma display panel comprising: i) a substrate in which a display area on which an image is displayed and a non-display area outside of the display area are defined, ii) a plurality of discharge electrodes that extend from the display area to the non-display area and are patterned to have different lengths from each other and iii) a plurality of dielectric layers that bury the discharge electrodes and have different areas for burying each of a plurality of electrode terminals extending from the discharge electrodes. The electrode terminals may be arranged in a way that the lengths of some of the electrode terminals gradually increase in a direction of the substrate, the lengths of some of the electrode terminals gradually decrease in a direction of the substrate, and the lengths of some of the electrode terminals are mixed with the two cases.

The electrode terminals may extend from the display area to the non-display area as one unit with the discharge electrodes and have different lengths from each other in the non-display area.

The dielectric layers for burying the electrode terminals may have different lengths from each other.

The dielectric layers may comprise a first dielectric layer that simultaneously buries the discharge electrodes disposed in the display area and second dielectric layers extending from the first dielectric layer to individually bury the electrode terminals.

The electrode terminals may have a stripe shape, and the second dielectric layers have a stripe shape that buries the electrode terminals.

End portions of the electrode terminals may not be buried by the second dielectric layers in order to be exposed to the outside.

The discharge electrodes may be grouped into a plurality of discharge electrode groups, and a plurality of align mark units are formed between an end portion of each of the discharge electrode groups and an edge of the substrate.

Another aspect of the present invention provides a plasma display panel comprising: i) a substrate in which a display area where an image is displayed and a non-display area outside the display area are defined, ii) a plurality of discharge electrodes that extend from the display area to the non-display area and are patterned to have different lengths from each other, iii) a plurality of dielectric layers that bury the discharge electrodes and have different areas for burying each of a plurality of electrode terminals extending from the discharge electrodes and iv) a signal transmitting unit that is electrically connected to the electrode terminals and comprises lead terminals in positions of the signal transmitting unit corresponding to the positions of the electrode terminals.

The signal transmitting unit may comprise a flexible film in which a plurality of leads are buried, and terminals of the leads having different distances from an edge of the flexible film are exposed to the outside.

The terminals of the leads to be connected to the electrode terminals may be respectively disposed in positions of the flexible film corresponding to positions of the electrode terminals having different lengths on the substrate.

The substrate and the signal transmitting unit may further comprise align mark units that align the position of the signal transmitting unit to the electrode terminals.

The align mark units may comprise first align mark units formed on a side of the electrode terminals and second align mark units formed on a side of the signal transmitting unit and aligned with the first align mark units.

The plurality of discharge electrodes may be grouped into a plurality of discharge electrode groups, and the first align mark units are formed between end portions of the electrode terminals of a discharge electrode group and the edge of the substrate, and the second align mark units are formed between the terminals of the leads and the edge of the flexible film. Another aspect of the invention provides a plasma display panel comprising: i) a substrate comprising i) a display portion configured to display an image and ii) a non-display portion from which an image is not displayed, ii) a plurality of discharge electrodes extending from the display portion to the non-display portion, wherein the plurality of discharge electrodes have different lengths from each other and iii) a plurality of dielectric layers configured to cover the discharge electrodes formed in the display portion, wherein the plurality of dielectric layers extend toward the non-display portion so as to cover a portion of each of the plurality of discharge electrodes formed in the non-display portion, wherein the plurality of discharge electrodes comprise a plurality of electrode terminals at their ends, respectively, and wherein the plurality of electrode terminals are formed in the non-display portion and not covered by the plurality of dielectric layers.

The electrode terminals may be arranged in a way that the lengths of some of the electrode terminals gradually increase in a direction of the substrate, and the lengths of some of the electrode terminals gradually decrease in the direction of the substrate. The electrode terminals may extend from the discharge electrodes in the display portion as one unit with the discharge electrodes and may have different lengths from each other in the non-display portion. The dielectric layers, formed in the non-display portion, may have different lengths from each other. The dielectric layers may comprise a first dielectric layer formed in the display portion and a plurality of second dielectric layers formed in the non-display portion and extending from the first dielectric layer, and wherein each of the plurality of second dielectric layers may cover a portion of each of the plurality of discharge electrodes. The electrode terminals may have a stripe shape, and the plurality of second dielectric layers may have a stripe shape corresponding to the stripe shape of the electrode terminals. At least two adjacent discharge electrodes may have lengths substantially different from each other.

Another aspect of the invention provides a plasma display panel comprising: i) a substrate comprising i) a display portion configured to display an image and ii) a non-display portion from which an image is not displayed, ii) a plurality of discharge electrodes extending from the display portion to the non-display portion, wherein the plurality of discharge electrodes have substantially different lengths from each other, iii) a plurality of dielectric layers configured to cover the discharge electrodes formed in the display portion, wherein the plurality of dielectric layers extend toward the non-display portion so as to cover a portion of each of the plurality of discharge electrodes formed in the non-display portion, wherein the plurality of discharge electrodes comprise a plurality of electrode terminals at their ends, respectively, and wherein the plurality of electrode terminals are formed in the non-display portion and not covered by the plurality of dielectric layers and iv) a signal transmitting unit electrically connected to the electrode terminals, wherein the signal transmitting unit comprises lead terminals corresponding to positions of the electrode terminals.

The electrode terminals may be arranged in a way that the lengths of some of the electrode terminals gradually increase in a direction of the substrate, and the lengths of some of the electrode terminals gradually decrease in a direction of the substrate. The signal transmitting unit may comprise a flexible film covering a substantial portion of a plurality of leads, and wherein terminals of the leads may have different distances from each other with respect to an edge of the flexible film and are not covered by the flexible film. The terminals of the leads that are to be connected to the electrode terminals may be respectively formed in positions of the flexible film corresponding to positions of the electrode terminals having different lengths from each other on the substrate. The electrode terminals may extend from the discharge electrodes in the display portion as one unit with the discharge electrodes and have different lengths from each other in the non-display portion. The dielectric layers formed in the non-display portion may have different lengths from each other. The dielectric layers may comprise a first dielectric layer formed in the display portion and covering the discharge electrodes and a plurality of second dielectric layers extending from the first dielectric layer, and wherein each of the plurality of second dielectric layers may cover a portion of each of the plurality of discharge electrodes. The electrode terminals may have a stripe shape, and the second dielectric layers may have a stripe shape corresponding to the stripe shape of the electrode terminals.

Still another aspect of the invention provides a plasma display panel comprising: i) a substrate comprising i) a display portion configured to display an image and ii) a non-display portion from which an image is not displayed, ii) a plurality of discharge electrodes extending from the display portion to the non-display portion, wherein at least two adjacent discharge electrodes have substantially different lengths from each other, and wherein each of the plurality of discharge electrodes comprises an end portion extending therefrom and formed in the non-display portion and iii) at least one dielectric layer configured to cover the discharge electrodes formed in the display portion, wherein the at least one dielectric layer extends toward the non-display portion so as to cover portions of each of the plurality of discharge electrodes formed in the non-display portion, wherein the end portions of the plurality of discharge electrodes are not covered by the at least one dielectric layer.

The at least one dielectric layer may be a single layer, wherein the single layer may comprise a first sub-layer formed in the display portion and a second sub-layer extending from the first sub-layer toward the non-display portion, and wherein the second sub-layer may cover the portions of each of the plurality of discharge electrodes. The at least one dielectric layer may comprise a first dielectric layer formed in the display portion and a second dielectric layer connected to the first dielectric layer, and wherein the second dielectric layer may cover the portions of each of the plurality of discharge electrodes.

### BRIEF DESCRIPTION OF THE DRAWINGS

Embodiments of the present invention will be described with reference to the attached drawings.

FIG. 1 is a plan view illustrating a typical aligned state of discharge electrodes and a signal transmitting unit.

FIG. 2 is cutaway perspective view illustrating a plasma display panel according to an embodiment of the present invention.

FIG. 3 is a schematic drawing illustrating an aligned state of the plasma display panel of FIG. 2, a signal transmitting unit, and a driving circuit board, according to an embodiment of the present invention.

FIG. 4 is a plan view illustrating an aligned state of discharge electrodes and a signal transmitting unit according to an embodiment of the present invention.

FIG. 5 is an exploded perspective view of the aligned state of the discharge electrodes and the signal transmitting unit of FIG. 4, according to an embodiment of the present invention.

FIG. 6 is a plan view illustrating an aligned state of discharge electrodes and a signal transmitting unit according to another embodiment of the present invention.

### DETAILED DESCRIPTION OF CERTAIN INVENTIVE EMBODIMENTS

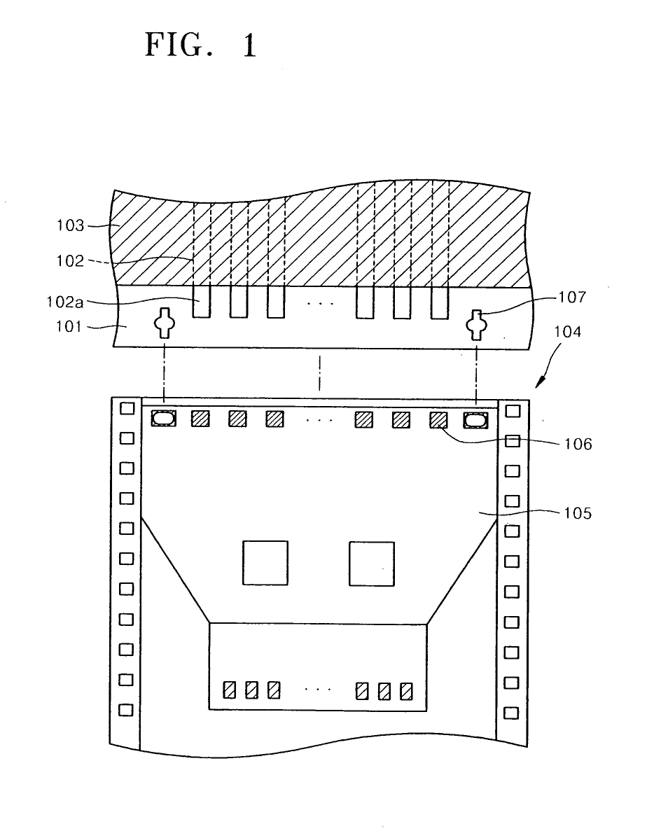

FIG. 1 is a plan view illustrating a typical arrangement of a plurality of discharge electrodes 102 and a signal transmitting unit 104. Referring to FIG. 1, the discharge electrodes 102 are spaced apart by an equal distance from each other on a substrate 101 in a direction of the substrate 101. The discharge electrodes 102 are buried in a dielectric layer 103. A plurality of electrode terminals 102a of the discharge electrodes 102 are not covered by the dielectric layer 103 but are exposed instead.

The electrode terminals 102a are combined with the signal transmitting unit 104. The signal transmitting unit 104 is continuously disposed on a reel-to-reel film 105, and is then separated into individual units through a punching process. Afterwards, a plurality of lead terminals 106 of the signal transmitting unit 104 are electrically connected to the electrode terminals 102a of the discharge electrodes 102.

Align mark units 107 for correctly connecting the lead terminals 106 of the signal transmitting unit 104 with the electrode terminals 102a of the discharge electrodes 102 are formed on positions outside both the outermost electrode terminals 102a and on regions of the reel-to-reel film 105 corresponding to the positions outside both the outermost electrode terminals 102a.

The above connection between the electrode terminals 102a of the discharge electrodes 102 and the lead terminals 106 of the signal transmitting unit 104 has the following characteristics.

First, when a plasma display panel is manufactured as a full high definition (HD) class plasma display panel, the number of channels of the electrode terminals 102a of the discharge electrodes 102 increases more than the number of channels of a HD class plasma display panel. Accordingly, the line width between the electrode terminals 102a decreases. Hence, a main component, for example, Ag, that constitutes the discharge electrodes 102 ionizes due to moisture in the air, and thus, a short circuit occurs between adjacent discharge electrodes 102.

Second, as the size of the plasma display panel increases, the regions for forming the align mark units 107 are reduced or none.

Embodiments of the present invention will now be described more fully with reference to the accompanying drawings in which exemplary embodiments of the invention are shown.

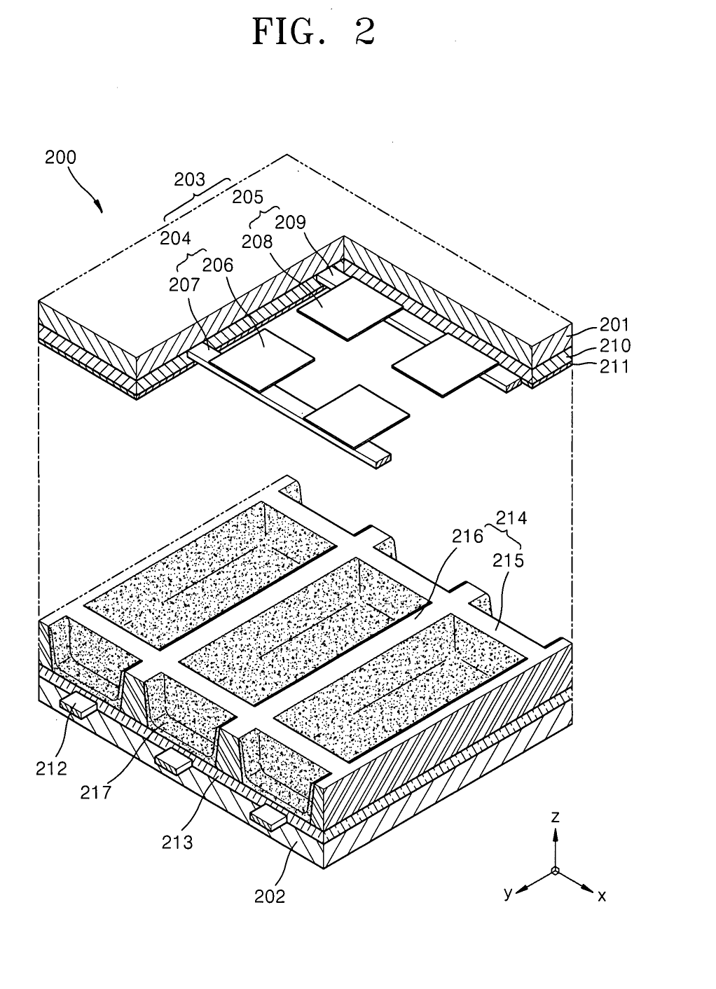

FIG. 2 is a cutaway perspective view illustrating a three-electrode surface discharge type plasma display panel (PDP) 200 according to an embodiment of the present invention.

Referring to FIG. 2, the three-electrode surface discharge type PDP 200 includes a first substrate 201 and a second substrate 202 parallel to the first substrate 201. Frit glass (not shown) may be coated along inner edge surfaces of the first and second substrates 201 and 202 to form sealed discharge spaces.

The first substrate 201 can be a transparent substrate such as soda lime glass, a semi-transparent substrate, a reflective substrate, or a colored substrate.

A plurality of sustain discharge electrode pairs 203 are formed on an inner surface of the first substrate 201. Each of the sustain discharge electrode pairs 203 includes an X electrode 204 and a Y electrode 205, and a pair of the X electrode 204 and the Y electrode 205 are disposed in each of a plurality of discharge cells of the three-electrode surface discharge type PDP 200.

The X electrode 204 includes a first transparent electrode 206 independently disposed in each discharge cell of the three-electrode surface discharge type PDP 200 and a first bus electrode line 207 that extends along the discharge cells adjacently disposed in an X direction of the PDP 200 and electrically connects the first transparent electrodes 206 of each of the discharge cells of the three-electrode surface discharge type PDP 200.

The Y electrode 205 includes a second transparent electrode 208 independently disposed in each discharge cell of the three-electrode surface discharge type PDP 200 and a second bus electrode line 209 that extends along the discharge cells adjacently disposed in an X direction of the three-electrode surface discharge type PDP 200 and electrically connects the second transparent electrodes 208 of each of the discharge cells of the three-electrode surface discharge type PDP 200.

In one embodiment, the first transparent electrode 206 and the second transparent electrode 208 have a rectangular horizontal cross-section, do not contact each other in the center of the discharge cells, and form a discharge gap by being disposed a predetermined distance apart from each other. In one embodiment, the first bus electrode line 207 and the second bus electrode line 209 are disposed on both side edges of the discharge cells by facing each other and have a stripe shape.

In one embodiment, the first transparent electrode 206 and the second transparent electrode 208 are formed of a transparent conductive film such as an indium tin oxide (ITO) film, and the first bus electrode line 207 and the second bus electrode line 209 are formed of, for example, an Ag paste having high conductivity or a metal material such as Cr—Cu—Cr.

A first dielectric layer 210 buries the X electrode 204 and the Y electrode 205 of each of the discharge cells and the first dielectric layer 210 may be formed by coating a transparent dielectric such as a high dielectric material, for example, PbO—B₂O₃—SiO₂.

A passivation film layer 211 may be formed by depositing, for example, MgO on a lower surface of the first dielectric layer 210 to increase the emission of secondary electrons.

The second substrate 202 can be a transparent substrate, a semi-transparent substrate, a reflective substrate, or a colored substrate. A plurality of address electrodes 212 are formed on an inner surface of the second substrate 202 in a direction substantially perpendicularly crossing the Y electrode 205 of the discharge cells.

The address electrodes 212 may extend across the discharge cells by being disposed in a Y direction of the three-electrode surface discharge type PDP 200 and have a stripe shape. A second dielectric layer 213 buries the address electrodes 212 of the discharge cells and the second dielectric layer 213 is formed of the substantially same material used for forming the first dielectric layer 210.

A plurality of barrier ribs 214 are formed between the first substrate 201 and the second substrate 202. The barrier ribs 214 define the discharge cells of the three-electrode surface discharge type PDP 200 and prevent cross-talk between adjacent discharge cells.

In one embodiment, the barrier ribs 214 include first barrier ribs 215 disposed in the X direction of the three-electrode surface discharge type PDP 200 and second barrier ribs 216 disposed in the Y direction of the three-electrode surface discharge type PDP 200. The first barrier ribs 215 may extend from an inner wall of a second barrier rib 216 toward the inner wall of another (adjacent) second barrier rib 216 to define matrix shaped discharge spaces.

In another embodiment, the barrier ribs 214 can be any structure that can define discharge cells, and the horizontal cross-section of the discharge cells can be various shapes such as a polygonal shape including a rectangular shape, or a circular or an oval shape.

A discharge gas such as a Ne—Xe gas or a He—Xe gas is injected into the discharge spaces defined by combining the first substrate 201, the second substrate 202, and the barrier ribs 214.

A phosphor layer 217 is formed in each of the discharge cells of the three-electrode surface discharge type PDP 200. The phosphor layer 217 of each of the discharge cells emits visible light when the phosphor layer 217 is excited by ultraviolet rays generated from the discharge gas during discharge. The phosphor layer 217 can be coated on any region in the discharge cell, and in one embodiment, the phosphor layer 217 is formed on an upper surface of the second dielectric layer 213 and on inner walls of the first barrier rib 214.

The phosphor layer 217 includes red, green, and blue phosphor layers, however, the phosphor layer 217 is not limited thereto. In one embodiment, the red phosphor layer includes (Y,Gd)BO₃;Eu⁺³, the green phosphor layer includes Zn₂SiO₄:Mn²⁺, and the blue phosphor layer includes BaMgAl₁₀O₁₇:Eu²⁺.

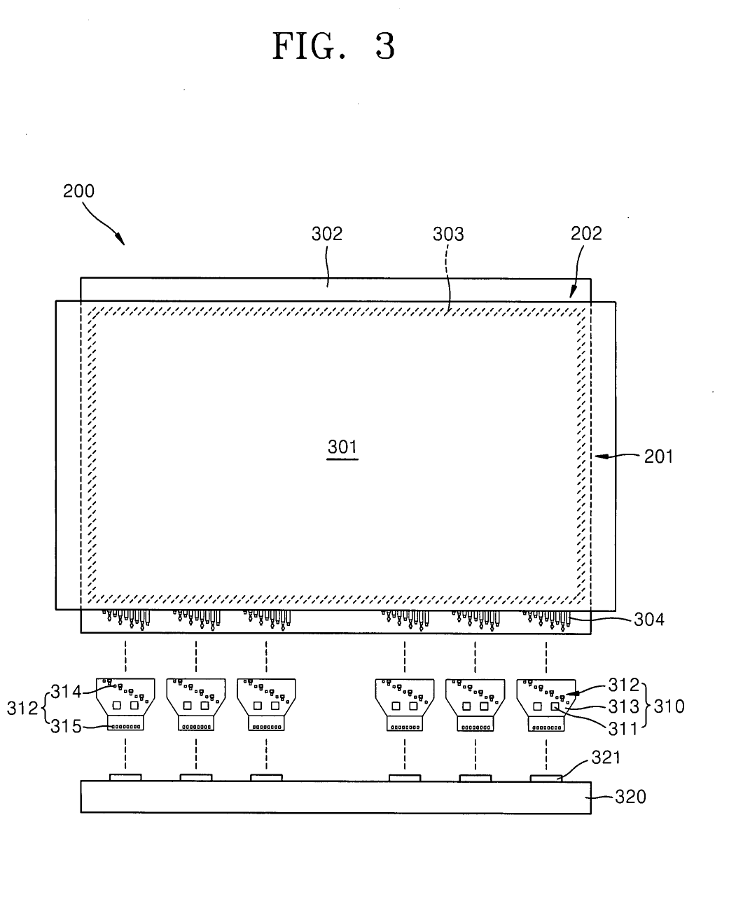

FIG. 3 is a schematic drawing illustrating an aligned state of the three-electrode surface discharge type PDP 200 of FIG. 2, a plurality of signal transmitting units 310, and a driving circuit board 320.

In one embodiment, the three-electrode surface discharge type PDP 200 is divided into a display area 301 where the first substrate 201 and the second substrate 202 overlap and a non-display area 302 in which one of the first and second substrates 201 and 202 is exposed at an edge of the display area 301. Frit glass 303 may be coated on boundary regions between the display area 301 and the non-display area 302 to seal the display area 301 from the outside.

The display area 301 may include a region in which various functional layers such as a plurality of electrodes, dielectric layers, barrier ribs, phosphor layers can be designed in various patterns on inner surfaces of the first and second substrates 201 and 202, and displays an image during discharge. The non-display area 302 may include a region in which a plurality of electrode terminals 304 of the discharge electrodes extending from the display area 301 are disposed, and the electrode terminals 304 in the non-display area 302 are electrically connected to a plurality of signal transmitting units 310.

In one embodiment, the electrode terminals 304 are disposed along the non-display area 302, and are disposed on more than one of the regions exposed from the region where the first substrate 201 and the second substrate 202 overlap according to a method of patterning the discharge electrodes.

In one embodiment, as the three-electrode surface discharge type PDP 200 becomes larger and in order to connect the electrode terminals 304 disposed in the non-display area 302 with the signal transmitting units 310, respectively, the electrode terminals 304 are grouped as a plurality of electrode terminal groups, and hence, each of the electrode terminal groups is connected to an individual signal transmitting unit 310.

The signal transmitting units 310 are able to transmit electrical signals since an end of the signal transmitting units 310 are connected to the electrode terminals 304 and another end thereof is connected to a driving circuit board 320. The electrode terminals 304 can be configured in various structures. In one embodiment, each of the signal transmitting units 310 includes a plurality of driving integrated circuits (ICs) 311, a lead 312 patterned to be connected to the driving ICs 311, and a flexible film 313 that entirely covers the lead 312 except for the electrode terminals 304 and a portion where the lead 312 is connected to a connector 321. A first terminal unit 314 formed on an end portion of the lead 312 is electrically connected to the electrode terminal 304, and a second terminal unit 315 formed another end portion of the lead 312 is electrically connected to the connector 321.

In one embodiment, the discharge electrodes extend from the display area 301 to the non-display area 302 with different (substantially or significantly different) lengths from each other, and dielectric layers that bury each of the electrode terminals 304 of the discharge electrodes extending from the display area 301 have different areas for each discharge electrode, which will now be described more in detail.

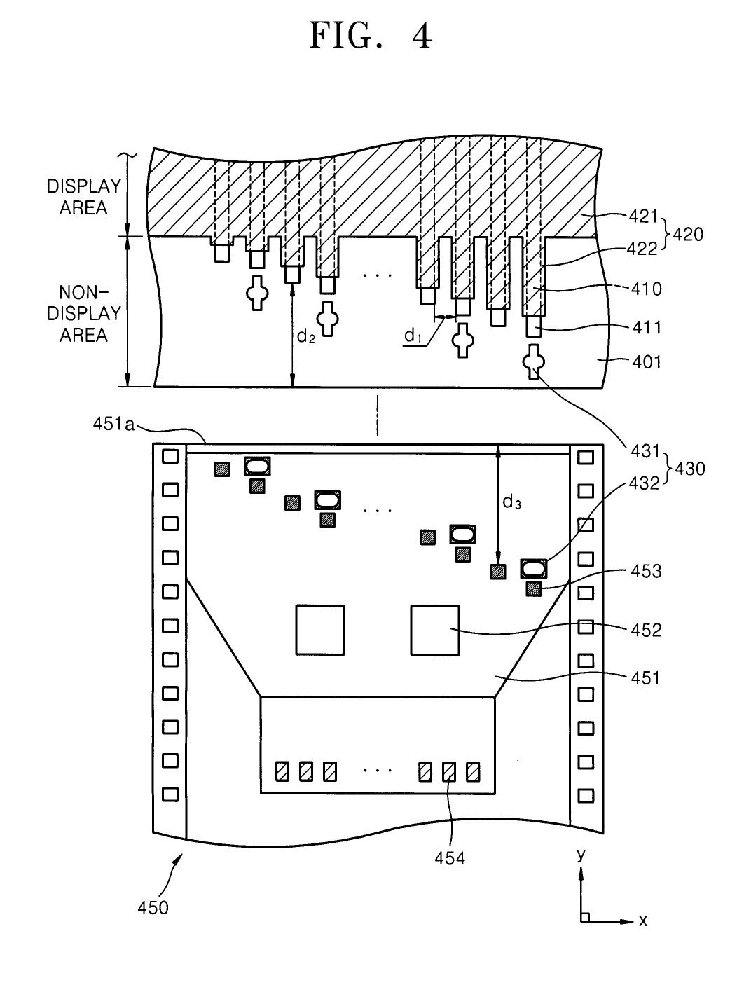

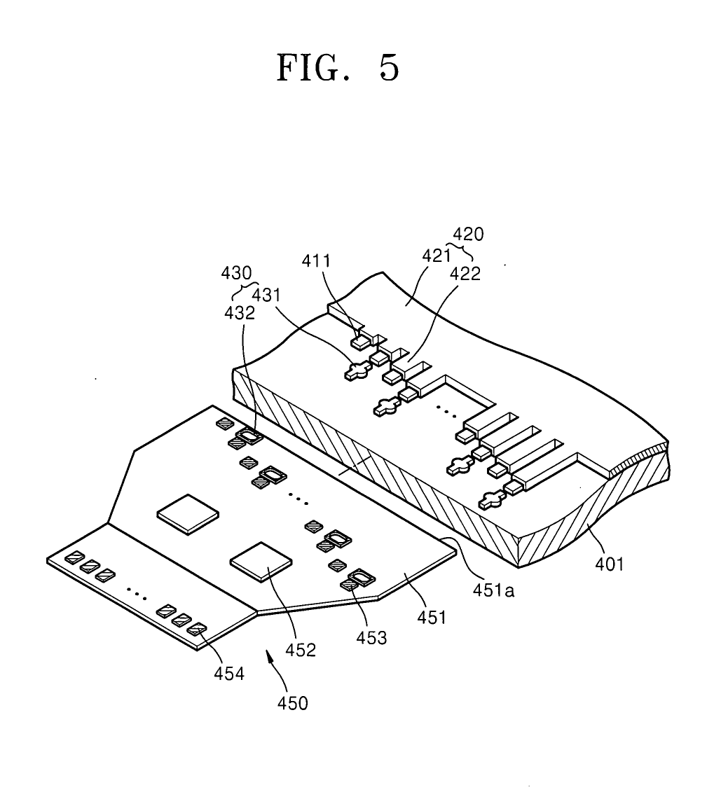

FIG. 4 is a plan view illustrating an aligned state of a plurality of discharge electrodes 410 and a signal transmitting unit 450 according to an embodiment of the present invention, and FIG. 5 is an exploded perspective view of the aligned state of a plurality of discharge electrodes 410 and the signal transmitting unit 450 of FIG. 4.

Referring to FIGS. 4 and 5, the discharge electrodes 410 are formed on a substrate 401. In one embodiment, the discharge electrodes 410 are spaced by a predetermined substantially equal gap d1 from each other in an X direction of the substrate 401. The discharge electrodes 410 may extend from a display area to a non-display area of the substrate 401 in a Y direction of the substrate 401 and have a stripe shape and the discharge electrodes 410 are buried by a dielectric layer 420.

In one embodiment, the discharge electrodes 410 are patterned on the substrate 401 having different (substantially or significantly different) lengths from each other. In this embodiment, electrode terminals 411 extending as one unit with the discharge electrodes 410 from the display area to the non-display area are disposed in the non-display area having different (substantially or significantly different) lengths from each other, and the length of the electrode terminals 411 gradually increases in the X direction of the substrate 401. In another embodiment, the length of the electrode terminals 411 gradually can decrease in the X direction of the substrate 401. In this embodiment, the distance d2 from an end of each of the electrode terminals 411 to an edge of the substrate 401 gradually decreases in the X direction while the length of the electrode terminals 411 gradually increases in the X direction. In another embodiment, at least two adjacent electrode terminals 411 have lengths substantially or significantly different from each other. In this embodiment, some of the electrode terminals 411, not adjacent to each other, may have substantially the same lengths as long as they do not cause a short circuit. This may apply to the remaining embodiments.

Also, portions of the dielectric layer 420 that cover the electrode terminals 411 may have different (substantially or significantly different) lengths. Hence, the dielectric layer 420 may include a first dielectric layer 421 that buries the discharge electrodes 410 disposed in the display area and second dielectric layers 422 extending from an edge of the first dielectric layer 421 to individually bury the electrode terminals 411.

The first dielectric layer 421 covers the discharge electrodes 410 disposed in the display area. The first dielectric layer 421 may be formed on the entire region of the substrate 401 to cover all the discharge electrodes 410.

The second dielectric layers 422 may protrude from an edge of the first dielectric layer 421 to the non-display area to individually bury the electrode terminals 411. The second dielectric layers 422 may selectively bury portions of the electrode terminals 411. In one embodiment, since the electrode terminals 411 have a stripe shape, the second dielectric layers 422 that bury the electrode terminals 411 also have a stripe shape. In another embodiment, the second dielectric layers 422 can be any shape as long as the second dielectric layers 422 can bury portions of the electrode terminals 411. In one embodiment, end portions of the electrode terminals 411 are not buried by the second dielectric layers 422, but predetermined lengths of the end portions of the electrode terminals 411 are exposed to the outside. In another embodiment, an integrally formed single layer can replace the first and second dielectric layers 421, 422.

The electrode terminals 411 are electrically connected to the signal transmitting unit 450. The signal transmitting unit 450 includes a flexible film 451. A plurality of driving integral circuits (ICs) 452 are mounted on the flexible film 451. A lead (not shown), connected to the driving ICs 452, is buried in the flexible film 451, and first lead terminals 453 and second lead terminals 454 are exposed to the outside. The first lead terminals 453 can be electrically connected to the electrode terminals 411 and the second lead terminals 454 can be electrically connected to a connector (not shown) of a driving circuit board.

In one embodiment, the first lead terminals 453 are disposed with different (substantially or significantly different) distances d3 from each other from an edge 451a of the flexible film 451. In this embodiment, the first lead terminals 453 that are to be connected to the electrode terminals are respectively exposed in positions of the flexible film 451 corresponding to positions of the electrode terminals 411 having different (substantially or significantly different) lengths in the non-display area.

In one embodiment, the distance d3 from the first lead terminals 453 to the edge 451a of the flexible film 451 gradually increases in the X direction by corresponding to the decrease in the distance d2 from the edges of the electrode terminals 411 to the edge of the substrate 401 in the X direction.

Align mark units 430 for aligning a position of the signal transmitting unit 450 with the electrode terminals 411 may be formed in the substrate 401 and the signal transmitting unit 450. Furthermore, a plurality of first align mark units 431 may be formed in the substrate 401 and a plurality of second align mark units 432, which are aligned with the first align mark units 431, may be formed in the signal transmitting unit 450.

In one embodiment, the discharge electrodes 410 are grouped into a plurality of discharge electrode groups on the substrate 401, for example, the discharge electrodes 410 in FIG. 4 is grouped into one discharge electrode group. The discharge electrode groups may be disposed in the X direction of the substrate 401.

The first align mark units 431 may be disposed between end portions of the electrode terminals 411 extending from a discharge electrode group and the edge of the substrate 401, and the first align mark units 431 may be disposed on inner sides of the discharge electrodes 410 of one discharge electrode group. The first align mark units 431 can be formed in one unit with the discharge electrodes 410. However, the first align mark units 431 may be independently formed from the discharge electrodes 410 in order to be respectively connected with the second align mark units 432.

The second align mark units 432 may be formed between the first lead terminals 453 and the edge 451a of the flexible film 451 on positions of the flexible film 451 corresponding to the positions of the first align mark units 431.

A method of connecting the signal transmitting unit 450 to the discharge electrodes 410 having the above-described structure will now be described.

First, the discharge electrodes 410 are patterned, that is, the discharge electrodes 410 having a stripe shape are spaced a predetermined gap d1 from each other. At this point, the discharge electrodes 410 are patterned to gradually increase in lengths from the edge of the display area to the edge of the substrate 401 in the X direction of the substrate 401 by varying the distances d2 from the edge of the substrate 401.

Then, the dielectric layer 420 is formed on the substrate 401 to bury the discharge electrodes 410. At this point, the first dielectric layer 421 is printed on the entire region of the substrate 401 to bury all the discharge electrodes 410 disposed in the display area.

Furthermore, the second dielectric layers 422 that are to be connected as one unit with the first dielectric layer 421 are printed on the discharge electrodes 410 in the non-display area to individually bury the discharge electrodes 410 extending from an edge of the first dielectric layer 421.

Next, the signal transmitting unit 450 is aligned with the substrate 401. At this point, the electrode terminals 411 on the substrate 401 correspond to the first lead terminals 453 on the flexible film 451 of the signal transmitting unit 450. In order to connect the electrode terminals 411 to the first lead terminals 453 in corresponding positions, the positions may be determined by overlapping the second align mark units 432 in the flexible film 451 with the first align mark units 431 in the substrate 401.

When the positions of the first lead terminals 453 with the electrode terminals 411 are determined through the above mentioned process, the electrode terminals 411 and the first lead terminals 453 are electrically connected using a thermal bonding method in a state where an anisotropic conductive film (not shown) such as an ACF is interposed between the electrode terminals 411 and the first lead terminals 453.

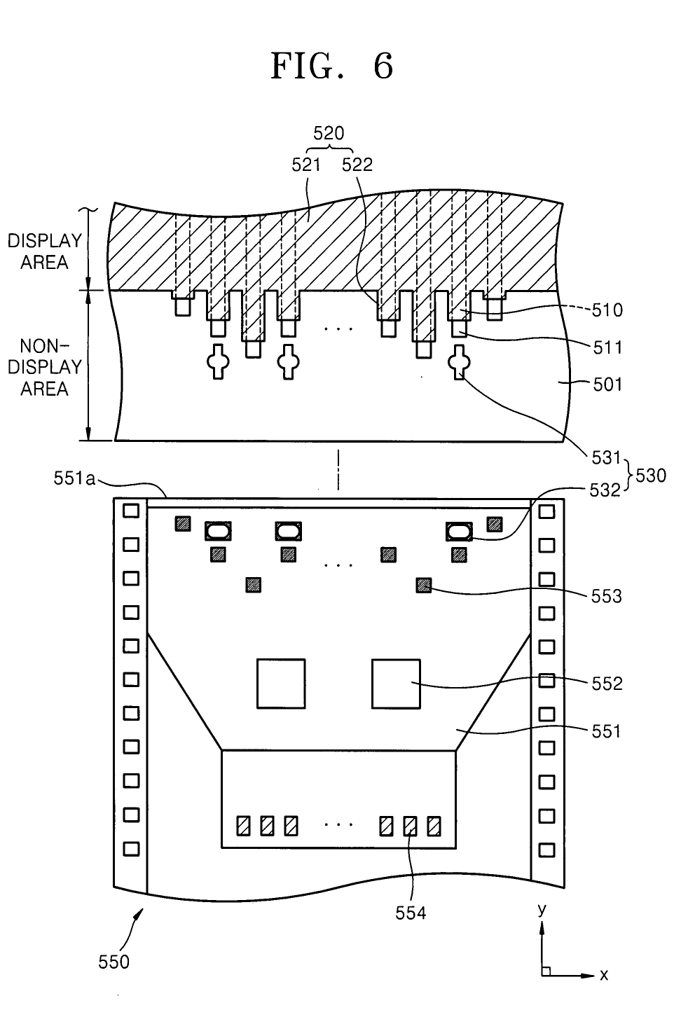

FIG. 6 is a plan view illustrating an aligned state of discharge electrodes 510 and a signal transmitting unit 550, according to another embodiment of the present invention.

Referring to FIG. 6, the discharge electrodes 510 are disposed on a substrate 501. In one embodiment, the discharge electrodes 510 are spaced apart by a predetermined gap in an X direction of the substrate 501 and have a stripe shape extending from a display area to a non-display area in a Y direction of the substrate 501. The discharge electrodes 510 are buried by a dielectric layer 520.

Electrode terminals 511 extending from the discharge electrodes 510 may have different (substantially or significantly different) lengths from each other in the non-display area. The lengths of some of the electrode terminals 511 may gradually increase in the X direction of the substrate 501, and the lengths of some of the electrode terminals 511 may gradually decrease in the X direction of the substrate 501.

Also, the dielectric layer 520 is formed to cover the electrode terminals 511 having different (substantially or significantly different) lengths from each other, and includes a first dielectric layer 521 that buries the discharge electrodes 510 disposed in the display area and second dielectric layers 522 extending from an edge of the first dielectric layer 521 towards the edge of the substrate 501 in order to bury the individual electrode terminals 511.

The electrode terminals 511 are electrically connected to the signal transmitting unit 550. The signal transmitting unit 550 includes a flexible film 551, a plurality of driving ICs 552 disposed on the flexible film 551, a lead (not shown) connected to the driving ICs 552, and first and second lead terminals 553 and 554, which are exposed to the outside.

The first lead terminals 553 may have different (substantially or significantly different) distances from each other with respect to an edge 551a of the flexible film 551. The first lead terminals 553 may be respectively exposed on positions of the flexible film 551 corresponding to the positions of the electrode terminals 511 on the substrate 501.

Align mark units 530 for aligning the position of the signal transmitting unit 550 with the electrode terminals 511 may be formed in the substrate 501 and the signal transmitting unit 550. The align mark units 530 may include first align mark units 531 in the substrate 501 and second align mark units 532 in the signal transmitting unit 550. The second align mark units 532 may determine the position of the signal transmitting unit 550 with the substrate 501 by corresponding to the positions of the first align mark units 531.

In one embodiment, the electrode terminals 511 having different (substantially or significantly different) distances from each other from the edge of the substrate 501 are electrically connected to the first lead terminals 553 on the flexible film 551.

As described above, at least one embodiment of the present invention provides the following advantages.

First, discharge electrodes having varying lengths are connected to lead terminals of a signal transmitting unit and thus, a short circuit between adjacent discharge electrodes can be prevented.

Second, even when the number of channels increases as plasma display panels increase in size, the gaps between adjacent electrode terminals for preventing the failure of discharge electrodes is constantly maintained.

Third, the alignment of positions between electrode terminals and leads is easy to attain.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A plasma display panel comprising:
a substrate comprising i) a display portion configured to display an image and ii) a non-display portion from which an image is not displayed;
a plurality of discharge electrodes extending from the display portion to the non-display portion, wherein the plurality of discharge electrodes have different lengths from each other; and
a plurality of dielectric layers configured to cover the discharge electrodes formed in the display portion, wherein the plurality of dielectric layers extend toward the non-display portion so as to cover a portion of each of the plurality of discharge electrodes formed in the non-display portion,
wherein the plurality of discharge electrodes comprise a plurality of electrode terminals at their ends, respectively, and wherein the plurality of electrode terminals are formed in the non-display portion and not covered by the plurality of dielectric layers.

2. The plasma display panel of claim 1, wherein the electrode terminals are arranged in a way that the lengths of some of the electrode terminals gradually increase in a direction of the substrate, and the lengths of some of the electrode terminals gradually decrease in the direction of the substrate.

3. The plasma display panel of claim 1, wherein the electrode terminals extend from the discharge electrodes in the display portion as one unit with the discharge electrodes and have different lengths from each other in the non-display portion.

4. The plasma display panel of claim 1, wherein the dielectric layers, formed in the non-display portion, have different lengths from each other.

5. The plasma display panel of claim 1, wherein the dielectric layers comprise a first dielectric layer formed in the display portion and a plurality of second dielectric layers formed in the non-display portion and extending from the first dielectric layer, and wherein each of the plurality of second dielectric layers covers a portion of each of the plurality of discharge electrodes.

6. The plasma display panel of claim 5, wherein the electrode terminals have a stripe shape, and the plurality of second dielectric layers have a stripe shape corresponding to the stripe shape of the electrode terminals.

7. The plasma display panel of claim 1, wherein at least two adjacent discharge electrodes have lengths substantially different from each other.

8. The plasma display panel of claim 1, wherein the discharge electrodes are grouped into a plurality of discharge electrode groups, and a plurality of align mark units are formed between an end portion of each of the discharge electrode groups and an edge of the substrate.

9. A plasma display panel comprising:
a substrate comprising i) a display portion configured to display an image and ii) a non-display portion from which an image is not displayed;
a plurality of discharge electrodes extending from the display portion to the non-display portion, wherein the plurality of discharge electrodes have substantially different lengths from each other;
a plurality of dielectric layers configured to cover the discharge electrodes formed in the display portion, wherein the plurality of dielectric layers extend toward the non-display portion so as to cover a portion of each of the plurality of discharge electrodes formed in the non-display portion, wherein the plurality of discharge electrodes comprise a plurality of electrode terminals at their ends, respectively, and wherein the plurality of electrode terminals are formed in the non-display portion and not covered by the plurality of dielectric layers; and
a signal transmitting unit electrically connected to the electrode terminals, wherein the signal transmitting unit comprises lead terminals corresponding to positions of the electrode terminals.

10. The plasma display panel of claim 9, wherein the electrode terminals are arranged in a way that the lengths of some of the electrode terminals gradually increase in a direction of the substrate, and the lengths of some of the electrode terminals gradually decrease in a direction of the substrate.

11. The plasma display panel of claim 9, wherein the signal transmitting unit comprises a flexible film covering a substantial portion of a plurality of leads, and wherein terminals of the leads have different distances from each other with respect to an edge of the flexible film and are not covered by the flexible film.

12. The plasma display panel of claim 11, wherein the terminals of the leads that are to be connected to the electrode terminals are respectively formed in positions of the flexible film corresponding to positions of the electrode terminals having different lengths from each other on the substrate.

13. The plasma display panel of claim 9, wherein the electrode terminals extend from the discharge electrodes in the display portion as one unit with the discharge electrodes and have different lengths from each other in the non-display portion.

14. The plasma display panel of claim 9, wherein the dielectric layers formed in the non-display portion have different lengths from each other.

15. The plasma display panel of claim 9, wherein the dielectric layers comprise a first dielectric layer formed in the display portion and covering the discharge electrodes and a plurality of second dielectric layers extending from the first dielectric layer, and wherein each of the plurality of second dielectric layers covers a portion of each of the plurality of discharge electrodes.

16. The plasma display panel of claim 15, wherein the electrode terminals have a stripe shape, and the second dielectric layers have a stripe shape corresponding to the stripe shape of the electrode terminals.

17. The plasma display panel of claim 9, wherein the electrode terminals_and the signal transmitting unit further comprise align mark units that align a position of the signal transmitting unit to a position of the electrode terminals.

18. The plasma display panel of claim 17, wherein the align mark units comprise first align mark units formed on a side of the electrode terminals and second align mark units formed on a side of the signal transmitting unit and aligned with the first align mark units.

19. The plasma display panel of claim 18, wherein the discharge electrodes are grouped into a plurality of discharge electrode groups, and the first align mark units are formed between end portions of the electrode terminals of a discharge electrode group and the edge of the substrate, and the second align mark units are formed between the terminals of the leads and the edge of the flexible film.

20. A plasma display panel comprising:
a substrate comprising i) a display portion configured to display an image and ii) a non-display portion from which an image is not displayed;
a plurality of discharge electrodes extending from the display portion to the non-display portion, wherein at least two adjacent discharge electrodes have substantially different lengths from each other, and wherein each of the plurality of discharge electrodes comprises an end portion extending therefrom and formed in the non-display portion; and
at least one dielectric layer configured to cover the discharge electrodes formed in the display portion, wherein the at least one dielectric layer extends toward the non-display portion so as to cover portions of each of the plurality of discharge electrodes formed in the non-display portion,
wherein the end portions of the plurality of discharge electrodes are not covered by the at least one dielectric layer.

21. The plasma display panel of claim 20, wherein the at least one dielectric layer is a single layer, wherein the single layer comprises a first sub-layer formed in the display portion and a second sub-layer extending from the first sub-layer toward the non-display portion, and wherein the second sub-layer covers the portions of each of the plurality of discharge electrodes.

22. The plasma display panel of claim 20, wherein the at least one dielectric layer comprises a first dielectric layer formed in the display portion and a second dielectric layer connected to the first dielectric layer, and wherein the second dielectric layer covers the portions of each of the plurality of discharge electrodes.
